(19) United States
(12) Patent Application Publication
(10) Pub. No.: US 2026/0257968 A1
(43) Pub. Date: Sep. 3, 2026

(54) USE OF ALKALINE SALT OF AN AMINO ACID FOR CARBONATION OF A MINERAL MATRIX

(71) Applicants: VICAT, L'Isle-d'Abeau (FR); INSTITUT NATIONAL DES SCIENCES APPLIQUEES DE LYON, Villeurbanne (FR); ECOLE SUPERIEURE DE CHIMIE PHYSIQUE ELECTRONIQUE DE LYON, Villeurbanne (FR); UNIVERSITE CLAUDE BERNARD LYON 1, Villeurbanne (FR); CENTRE NATIONAL DE LA RECHERCHE SCIENTIFIQUE, Paris (FR)

(72) Inventors: Laury BARNES-DAVIN, Voiron (FR); Emmanuel SCHMITT, Lyon (FR); Clara TOSI, Lyon (FR); Julien LECLAIRE, Theizé (FR)

(73) Assignees: VICAT, L'Isle-d'Abeau (FR); INSTITUT NATIONAL DES SCIENCES APPLIQUEES DE LYON, Villeurbanne (FR); ECOLE SUPERIEURE DE CHIMIE PHYSIQUE ELECTRONIQUE DE LYON, Villeurbanne (FR); UNIVERSITE CLAUDE BERNARD LYON 1, Villeurbanne (FR); CENTRE NATIONAL DE LA RECHERCHE SCIENTIFIQUE, Paris (FR)

(21) Appl. No.: 18/877,662

(22) PCT Filed: Jun. 19, 2023
(86) PCT No.: PCT/FR2023/050888

§ 371 Date: Dec. 20, 2024

(30) Foreign Application Priority Data
Jun. 20, 2022 (FR) FR22/06010

(51) Int. Cl. C04B 20/02; C04B 111/00

(52) U.S. Cl. CPC C04B 20/023; C04B 2111/00017

(57) ABSTRACT

Use of an alkaline salt of a proteinogenic amino acid selected from alanine (Ala), arginine (Arg), asparagine (Asn), aspartate (Asp), cysteine (Cys), glutamate (Glu), glutamine (Gln), histidine (His), isoleucine (Ile), leucine (Leu), methionine (Met), phenylalanine (Phe), proline (Pro), pyrrolysine (Pyl), selenocysteine (Sec), serine (Ser), threonine (Thr), tryptophan (Trp), tyrosine (Tyr), valine (Val) and lysine (Lys) or one of its derivatives of formula (I)

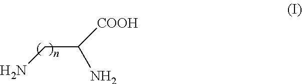

wherein n is an integer equal to 1, 2, 3 or 5; and their optical isomers, for the carbonation of an alkaline earth metal hydroxide, silicate, aluminate, phosphate, chloride or sulfate or of a material containing an alkaline earth metal oxide, silicate, aluminate, phosphate, chloride or sulfate.

The present invention relates to the use of alkaline salt of amino acid for carbonation of mineral matrix.

The manufacture of hydraulic binders, and in particular that of cements, essentially consists in calcining a mixture of carefully selected and dosed raw materials, also called «raw-mix». The cooking of this raw-mix gives an intermediate product, the clinker, which, milled with calcium sulfate and possible mineral additions, will give cement. The type of manufactured cement depends on the nature and proportions of the raw materials as well as the cooking method. There are several types of cements: Portland cements (which represent most of cements produced in the world), aluminous cements (or calcium aluminate), natural quick setting cements, sulfo-aluminous cements, sulfo-belitic cements and other intermediate varieties.

The most common cements are the Portland type cements. The Portland cements are obtained from Portland clinker, obtained after clinkering at a temperature in the range of 1450° C. of a raw-mix rich in calcium carbonate in a furnace. The production of one ton of Portland cement is accompanied by the emission of very large quantities of CO₂ (about 0.8 to 0.9 tons of CO₂ per ton of cement in the case of a clinker)

Yet, in 2014, the amount of cement sold around the world was around 4.2 billion tons (source: French Trade Union for the Cement Industry—SFIC). This figure, which is constantly increasing, has more than doubled in 15 years.

During the production of clinker, the main constituent of Portland cement, the release of CO₂ is linked to:
up to 40% for heating the cement kiln, in milling and in transport;
up to 60% of so-called chemical, or of decarbonation CO₂.

The decarbonation is a chemical reaction that takes place when limestone, the main raw material for making Portland cement, is heated at high temperature. The limestone is then transformed into quick lime and CO₂ according to the following chemical reaction:

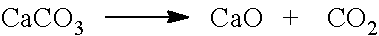

To reduce CO₂ emissions linked to the production of Portland cement, several approaches have been considered until now:
the adaptation or modernization of cement methods in order to maximize the efficiency of heat exchanges;
the development of new «low carbon» binders such as sulpho-aluminous cements prepared from raw materials less rich in limestone and at a lower cooking temperature, which allows a reduction in CO₂ emissions of about 35%;
or the (partial) substitution of clinker in cements with materials making it possible to limit CO₂ emissions.

Carbon capture and storage technologies have also been developed to limit CO₂ emissions, for example from cement plants, blast furnace steelworks or coal-fired power plants. Deep storage is possible but very limited, for example, by the geological context. Other possibilities and storage methods, for example by mineralization, must therefore be explored.

Among the different techniques allowing the trapping and storage of CO₂, the so-called «integrated absorption mineralization» or «IAM» pathway has been the subject of numerous studies, such as those of Meishen Liu et al., «Integrated CO₂ Capture, Conversion, and Storage To Produce Calcium Carbonate Using an Amine Looping Strategy», Energy Fuels, 2019, 33, 1722-1733, and «Integrated CO₂ Capture and Removal via Carbon Mineralization with Inherent Regeneration of Aqueous Solvents», Energy Fuels, 2021, 35, 8051-8068.

This pathway can be summarized by the following reaction scheme:

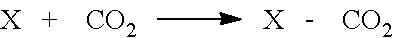

then

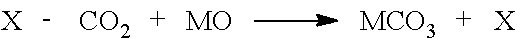

in which X denotes the CO₂ sensor and M denotes a mineral, in particular a mineral rich in calcium or magnesium.

It mainly consists of capturing the CO₂ using a solvent and then bringing the solution thus obtained into contact with a mineral acceptor such as CaO or MgO in order to carbonate it and thus obtain an insoluble and stable carbonate. The method generally implemented consists of a «one-pot» method in a closed system in which the mineral acceptor is suspended in a solution of CO₂ absorbent contained in a reactor under an atmosphere at constant pCO₂=1 atm, the depression induced by the absorption of CO₂ being compensated by the constant supply of gas containing CO₂. Once the reaction is complete, the solid (carbonated mineral acceptor) and liquid are separated by filtration, the solid is washed and the liquid phases are combined for reuse.

The CO₂ absorbents mainly used so far have been industrial amines, in particular monoethanolamine (MEA), diethanolamine (DEA), N-methyldiethanolamine (MDEA), 2-amino-2methylpropanol (AMP), piperazine and 1,8-diazabicyclo[5.4.0]undec-7-ene (DBU). However, in the IAM strategy, a crucial point for industrial development concerns the loss of the amine in the formed mineral carbonate matrix. Indeed, this sequestration induces a double economic penalty for a potential method:
consumption of the absorbent during IAM cycles and necessary replenishment; and
reduction of the market value of the formed carbonate.

Furthermore, the eco-toxicity of the used industrial amines strongly reduces the possibilities of using the carbonate finally formed.

As a result, research has also focused on the use of an alkaline amino acid salt, sodium glycinate (NaGly), to capture CO₂, particularly due to its environmental safety.

Although sodium glycinate is more environmentally acceptable than the industrial amines used to date, the use of this amino acid has a number of drawbacks, in particular in terms of yield and reaction kinetics, but also in terms of regeneration rate, which limits the industrial application of the IAM method using this CO₂ sensor.

It would therefore be interesting to identify new CO₂-capturing agents allowing the industrial implementation of the «IAM» pathway by improving the yield and kinetics of the reaction.

In «Efficient CO₂ Sequestration by a Solid-Gas Reaction Enabled by Mechanochemistry: The Case of L-Lysine», ACS Sustainable Chem. Eng. 2020, 8, 13159-13166, El-Terkawi et al. describe the use of L-lysine to capture CO₂. However, this publication does not describe the use of this amino acid in an IAM-type method for the carbonation of an alkaline earth metal oxide or silicate. Furthermore, since a proteinogenic amino acid (and not an alkaline salt thereof) is used, CO₂ trapping involves the formation of carbamates (and not carbonates) according to the following reaction:

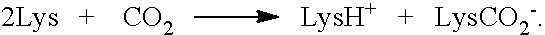

Yet, the formation of carbamates makes the carbonation of metals difficult.

In «CO₂ absorption into aqueous potassium salts of lysine and proline: Density, viscosity and solubility of CO₂», Fluid Phase Equilibria, 399 (2015) pages 40-49, Shen et al. describe the use of potassium of lysine or proline salts to capture CO₂.

However, again, this publication does not describe the use of these amino acids in an IAM-type method for the carbonation of an alkaline earth metal oxide or silicate.

The Chinese patent application CN 113 087 003 describes a method for trapping and storing CO₂ by bringing CaO into contact with an absorbent liquid which is a solution comprising an alkaline salt (K⁺, Na⁺ or Li⁺) of an amino acid (glycine, alanine, valine, leucine, isoleucine, phenylalanine, proline, tryptophan, serine, tyrosine, cysteine, methionine, asparagine, threonine, aspartic acid, glutamic acid, lysine, arginine or histidine). Only the use of sodium glycinate, potassium sarcosinate and L-proline potassium has been the subject of experimentation.

Moreover, this patent application makes no mention of the use of an alkaline salt of an amino acid for the carbonation of alkaline earth metal salts other than alkaline earth oxides. In particular, the carbonation of alkaline earth metal silicates is not mentioned. However, the carbonation of such salts presents particular difficulties requiring the application of complex and costly operating conditions (high temperature, addition of additives, depression, etc.) as reported in particular by Abass A. Olajire in «A review of mineral carbonation technology in sequestration of CO₂», Journal of Petroleum Science and Engineering, 109 (2013) 364-392.

Now, it has been found quite surprisingly that replacing glycine with other proteinogenic amino acids allows improving the yield and kinetics of the IAM reaction. Furthermore, the use of such proteinogenic amino acids allows the carbonation of alkaline earth metal silicate under mild operating conditions requiring little or no heat input. Finally, these proteinogenic amino acids allow, when used to carbonate certain alkaline earth metal salts, in particular alkaline earth metal hydroxides, to significantly improve the yield of the reaction compared to the yields obtained with alkaline earth metal oxides.

Thus, the subject of the present invention is the use of an alkaline salt of a proteinogenic amino acid selected from alanine (Ala), arginine (Arg), asparagine (Asn), aspartate (Asp), cysteine (Cys), glutamate (Glu), glutamine (Gln), histidine (His), isoleucine (Ile), leucine (Leu), methionine (Met), phenylalanine (Phe), proline (Pro), pyrrolysine (Pyl), selenocysteine (Sec), serine (Ser), threonine (Thr), tryptophan (Trp), tyrosine (Tyr), valine (Val) and lysine (Lys) or one of its derivatives of formula (I)

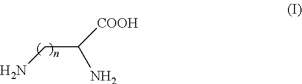

in which n is an integer equal to 1, 2, 3 or 5; and their optical isomers, for the carbonation of an alkaline earth metal hydroxide, silicate, aluminate, phosphate, chloride or sulfate or a material containing an alkaline earth metal oxide, silicate, aluminate, phosphate, chloride or sulfate.

The use of an alkali salt of a proteinogenic amino acid according to the invention instead of glycine makes it possible to improve the yield and kinetics of the IAM reaction.

In the context of the present invention:
the term «use for the carbonation of an alkaline earth metal hydroxide, silicate, aluminate, phosphate, chloride or sulfate or a material containing an alkaline earth metal hydroxide, silicate, aluminate, phosphate, chloride or sulfate» means any use in a method allowing to carbonate an alkaline earth metal oxide, silicate, aluminate, phosphate, chloride or sulfate or a material containing an alkaline earth metal hydroxide, silicate, aluminate, phosphate, chloride or sulfate, in particular any use in an «IAM» type method involving a CO₂ trapping step and a carbonation step of an alkaline earth metal oxide or silicate; and
the term «alkaline salt» means any addition salt obtained with a mineral or organic base by the action of such a base in an organic or aqueous solvent such as an alcohol, a ketone, an ether or a chlorinated solvent. As an example of such salts, we can notably cite ammonium (NH4⁺), calcium (Ca²⁺), iron (II) (Fe²⁺) or (III) (Fe³⁺), magnesium (Mg²⁺), potassium (K⁺), sodium (Na⁺) or lithium (Li⁺) salts. Preferably, «alkaline salt» means a potassium or sodium salt.

The present invention therefore relates to the use of an alkaline salt of a proteinogenic amino acid for the carbonation of an oxide, a silicate, an aluminate, a phosphate, a chloride or a sulfate of an alkaline earth metal or of a material containing an oxide, a silicate, an aluminate, a phosphate, a chloride or a sulfate of an alkaline earth metal. Preferably, the present invention has the following characteristics, taken alone or in combination:
the proteinogenic amino acid is selected as being arginine (Arg), asparagine (Asn), aspartate (Asp), cysteine (Cys), histidine (His) or lysine (Lys) or one of its derivatives of formula (I)

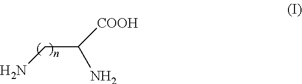

in which n is an integer equal to 1, 2, 3 or 5; as well as their optical isomers. Preferably, the proteinogenic amino acid is selected as being L-arginine (L-Arg), L-asparagine (L-Asn), L-aspartate (L-Asp), L-cysteine (L-Cys) or L-lysine (L-Lys). Most preferably, the amino acid is selected as being L-lysine (L-Lys);
the alkali salt of the proteinogenic amino acid is used for the carbonation of an alkaline earth metal hydroxide or silicate or a material containing an alkaline earth metal hydroxide or silicate;
the alkaline earth metal is selected as being calcium (Ca) or magnesium (Mg);
the alkaline earth metal hydroxide is selected as being Ca(OH)₂ or Mg(OH)₂; and/or
the alkaline earth metal silicate is selected as being CaSiO₃ or MgSiO₃.

The alkaline earth metal carbonates obtained using the proteinogenic amino acids according to the invention are insoluble and stable and therefore allow CO₂ to be stored sustainably. They are further reusable in various ways, for example as a filler in the context of cement production, as a mineral filler in various products or as an amendment.

The present invention can be illustrated in a non-limiting manner by the following examples.

### EXAMPLE 1—CARBONATION OF ALKALINE EARTH METAL HYDROXIDE

### 1.1—Implemented Methods

1.1.1—Carbonation from Solid Adducts

### Preparation of Solid Amino Acid-CO₂ Adducts (95% Capture Efficiency)

A solution containing 0.15 mol of amino acid and one equivalent of KOH per amine end of the amino acid are dissolved in 150 ml of a mixture of distilled water and methanol with a ratio of 1:5. The medium is stirred for 10 minutes at 300 rpm and then, if necessary, is filtered on a 4-pore frit to remove the excess white KCl precipitate.

CO₂ is introduced into the solution at 100 ml/min for 45 minutes (duration for a capture efficiency of 95%).

The formation of a white precipitate is observed.

At the end of the reaction, the precipitate is filtered on a pore 4 frit, washed cold with methanol and then dried under vacuum for 4 hours.

### Carbonation in Solution

The carbonation of calcium hydroxide is carried out using the solid amino acid-CO₂ adducts obtained previously with a metal:CO₂ molar ratio of approximately 1:1.

For this, 0.02 mol of alkaline earth metal hydroxide and 1 equivalent of CO₂ supported on the solid amino acid-CO₂ adduct are brought into contact, then 20 ml of distilled water are added.

The reactor is closed, immersed in a bath at controlled temperature (25° C.) and then stirred at 700 rpm for 3 hours.

The obtained solid is filtered, washed with distilled water and then the solid is dried for at least 12 hours in an oven at 90° C.

1.1.2—Carbonation from Adducts in Solution

### Preparation of Amino Acid-CO₂ Solutions (95% Capture Efficiency)

In 150 ml of a 1N amino acid solution with one equivalent of KOH per amine end of the amino acid, CO₂ is introduced into the solution at 100 ml/min until the CO₂ capture efficiency drops below 95%.

### Carbonation in Solution

The carbonation of calcium hydroxide is carried out using the amino acid-CO₂ solutions obtained previously with a metal:CO₂ molar ratio of approximately 1:1.

To do this, 1 equivalent of Ca(OH)₂ is added to the CO₂ in 20 ml of amino acid-CO₂ solution at a defined concentration (1.6 N).

The reactor is closed and immersed in a bath at controlled temperature (55° C.) then stirred at 700 rpm for 3 hours.

The obtained solid is filtered, washed with distilled water and then the solid is dried for at least 12 hours in an oven at 90° C.

### 1.2—Tested Amino Acids/Alkaline Earth Metal Hydroxide

TABLE 1
Tested amino acids/alkaline earth metal hydroxide

| | Alkaline earth | Molar ratio of metal |
|---|---|---|
| Amino acid | metal hydroxide | hydroxide:CO₂ |
| LysK (invention) | Ca(OH)₂ | 1 |
| GlyK (comparison) | Ca(OH)₂ | 1 |

### 1.3—Comparative Example: Tested Amino Acids/Alkaline Earth Metal Oxide

Following the same protocol, the carbonation of calcium oxides (CaO) in the presence of LysK was tested for comparison purposes.

### 1.4—Calculation of the Carbonation Rate and the Mineralization Yield of Calcium Oxide and Hydroxide

The carbonation rate of calcium hydroxide (or oxide) (ratio of moles of CO₂ fixed in the solid phase per mole of calcium in the solid) is determined by volumetric titration of the CO₂ expelled during the acid digestion of the solid obtained with a Chittick apparatus with a 3 ml burette.

To do this, an aliquot of dry solid of approximately 100-150 mg is titrated with 5 ml of 5M H₃PO₄ acid. The calibration of the apparatus is done at 25° C. with NaHCO₃ titrated with 5M H₃PO₄, thus obtaining a calibration curve of y=17.049 ml/mmol with R₂>0.995.

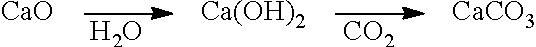

The carbonation rate Y_{c} is calculated according to the following equation:

$${Y}_{C} = {n CO}_{2} / {n Ca}^{2 +}$$

in which n represents the number of moles of each species.

The yield of mineralized CO₂ is then calculated according to the following equation:

$${Y}_{CO 2} = {Y}_{C} * 0.95$$

### 1.5—Results

1.5.1—Carbonation in Solution from Solid Adducts (at 25° C.)

TABLE 2
Carbonation rate and mineralization
yield of Ca(OH)₂ and CaO at 25° C.

| Amino acid | Alkaline earth metal | Y_{C} (%) | Y_{CO2} (%) |
|---|---|---|---|
| LysK(CO₂) | Ca(OH)₂ (invention) | 66.4 | 63.1 |
| LysK(CO₂) | CaO (comparison) | 55.7 | 52.9 |

1.5.2—Carbonation in Solution from Adducts in Solution (at 55° C.)

TABLE 3
Carbonation rate and mineralization
yield of Ca(OH)₂ and CaO at 55° C.

| | Alkaline | | | |
|---|---|---|---|---|
| Amino acid | earth metal | Y_{C} (%) | Y_{CO2} (%) | |
| LysK(CO₂) 0.5M | Ca(OH)₂ | 90.3 | 85.8 | Invention |
| LysK(CO₂) 0.5M | CaO | 73.0 | 69.3 | Comparison |
| GlyK(CO₂) 1M | Ca(OH)₂ | 75.4 | 67.9 | Comparison |

### 1.6—Conclusion

According to the obtained experimental results, the use of basic lysine salt makes it possible to significantly improve the carbonation rate of alkaline earth metal hydroxide compared to a basic glycine salt.

The improvement in the reaction yield allows its use at the industrial level to be considered.

Moreover, it is observed that the carbonation rate is significantly improved when using an alkaline earth metal hydroxide compared to the results obtained with an alkaline earth metal oxide.

### EXAMPLE 2—CARBONATION OF ALKALINE EARTH METAL SILICATE

### 2.1—Implemented Methods

2.1.1—Carbonation from Solid Adducts

### Preparation of Solid Amino Acid-CO₂ Adducts (95% Capture Efficiency)

A solution containing 0.15 mol of amino acid and one equivalent of KOH per amine end of the amino acid are dissolved in 150 ml of a mixture of distilled water and methanol with a ratio of 1:5. The medium is stirred for 10 minutes at 300 rpm and then, if necessary, is filtered on a 4-pore frit to remove the excess white KCl precipitate.

CO₂ is introduced into the solution at 100 ml/min for 45 minutes (duration for a capture efficiency of 95%).

The formation of a white precipitate is observed.

At the end of the reaction, the precipitate is filtered on a 4-pore frit, washed cold with methanol and then dried under a vacuum ramp for 4 hours.

### Carbonation

### Dry Grinding/Mechanical Chemistry

The carbonation of calcium silicate is then carried out with a molar ratio of metal hydroxide:CO₂ of approximately 1:1. A small amount of water is added to reach LAG conditions (η=0.5 mg/mL). The grindings are done in a 20 ml WC reactor with 40 balls of 5 mm diameter at 500 rpm for 30 minutes.

The obtained solid is recovered and filtered, washed with distilled water and then the solid is dried for at least 12 hours in an oven at 90° C.

### Carbonation in Solution

The carbonation of calcium silicate is carried out using the solid amino acid-CO₂ adducts obtained previously with a metal:CO₂ molar ratio of approximately 1:1.

For this, 0.02 mol of alkaline earth metal hydroxide and 1 equivalent of CO₂ supported on the solid amino acid-CO₂ adduct are brought into contact, then 20 ml of distilled water are added.

The reactor is closed, immersed in a bath at controlled temperature (25° C.) and then stirred at 700 rpm for 3 hours.

The obtained solid is filtered, washed with distilled water and then the solid is dried for at least 12 hours in an oven at 90° C.

2.1.2—Carbonation from Adducts in Solution

### Preparation of Amino Acid-CO₂ Solutions (95% Capture Efficiency)

In 150 ml of a 1N and 2N amino acid solution with one equivalent of KOH per amine end of the amino acid, CO₂ is introduced into the solution at 100 ml/min until the CO₂ capture efficiency drops below 95%.

### Carbonation in Solution

The carbonation of calcium silicate is carried out using the amino acid-CO₂ solutions obtained previously with a metal:CO₂ molar ratio of approximately 1:1.

To do this, 1 equivalent of CaSiO₃ is added to the CO₂ in 20 ml of amino acid-CO₂ solution at a defined concentration (1.6N).

The reactor is closed and immersed in a bath at controlled temperature (25° C., 55° C. or 75° C.) then stirred at 700 rpm for 3 hours.

The obtained solid is filtered, washed with distilled water and then the solid is dried for at least 12 hours in an oven at 90° C.

### 2.2—Tested Amino Acids/Alkaline Earth Metal Hydroxide

TABLE 4
Tested amino acid/alkaline earth metal silicate

| | Alkaline earth | Molar ratio of metal |
|---|---|---|
| Amino acid | metal hydroxide | hydroxide:CO₂ |
| LysK (invention) | CaSiO₃ | 1 |
| GlyK (comparison) | Ca(OH)₂ | 1 |

### 2.3—Calculation of the Carbonation Rate and the Mineralization Yield of Calcium Oxide and Hydroxide

The carbonation rate of calcium silicate (ratio of moles of CO₂ fixed in the solid phase per mole of calcium in the solid) is determined by volumetric titration of the CO₂ expelled during the acid digestion of the solid obtained with a Chittick apparatus with a 3 ml burette.

To do this, an aliquot of dry solid of about 100-150 mg is titrated with 5 ml of 5M H₃PO₄ acid. The calibration of the device is done at 25° C. with NaHCO₃ titrated with 5M H₃PO₄, thus obtaining a calibration curve of y=17.049 mL/mmol with R₂>0.995.

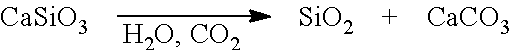

The carbonation rate Y_{c} is calculated according to the following equation:

$${Y}_{C} = {n CO}_{2} / {n Ca}^{2 +}$$

in which n represents the number of moles of each species.

The yield of mineralized CO₂ is then calculated according to the following equation:

$${Y}_{CO 2} = {Y}_{C} * 0.95$$

### 2.4—Results

### 2.4.1—Dry Carbonation

TABLE 5
Carbonation rate and mineralization
yield of CaSiO3 by dry method

| | Alkaline | | |
|---|---|---|---|
| Amino acid | earth metal | Y_{C} (%) | Y_{CO2} (%) |
| LysK(CO₂) (invention) | CaSiO₃ | 10.2 | 9.7 |
| GlyK(CO₂) (comparison) | CaSiO₃ | No solid GlyCO₂ | — |
| | | adduct obtained | |

2.4.2—Carbonation in Solution from Solid Adducts (at 25° C.)

TABLE 6
Carbonation rate and mineralization yield of CaSiO₃ at 25° C.

| Amino acid | Alkaline earth metal | Y_{C} (%) | Y_{CO2} (%) |
|---|---|---|---|
| LysK(CO₂) | CaSiO₃ | 13.2 | 11.9 |

2.4.3—Carbonation in Solution from Adducts in Solution

TABLE 7
Carbonation rate and mineralization yield of CaSiO₃

| | Alkaline | | | |
|---|---|---|---|---|
| Amino acid | earth metal | Temp. (in ° C.) | Y_{C} (%) | Y_{CO2} (%) |
| LysK(CO₂) 0.5M | CaSiO₃ | 25 | 14.6 | 13.9 |
| | | 55 | 15.5 | 14.7 |
| LysK(CO₂) 1M | CaSiO₃ | 25 | 14.1 | 13.4 |
| | | 55 | 15.3 | 14.5 |
| | | 75 | 20.7 | 19.7 |

### 2.5—Conclusion

According to the obtained experimental results, the use of basic lysine salt allows the carbonation of calcium silicate under conditions that reduce the required quantities of water, but which do not allow the use of glycine.

Moreover, the obtained carbonation rates are higher than those generally observed in the literature.

### EXAMPLE 3—CARBONATION OF ALKALINE EARTH METAL HYDROXIDE OR SILICATE

### 3.1—Implemented Method (Continuous Flow Carbonation)

The carbonation of calcium hydroxide or silicate is carried out by contacting a flow of CO₂ in a mixture of calcium salt in a 1N amino acid solution with one equivalent of KOH per amine end of the amino acid.

The CO₂ is introduced into the solution (volume 150 ml) at 100 ml/min at room temperature until the CO₂ capture efficiency drops below 95%, then the mixture is filtered, washed with distilled water and the solid is dried for at least 12 hours in an oven at 90° C.

### 3.2—Calculation of the Carbonation Rate and the Mineralization Yield of Calcium Hydroxide and Silicate

The calculation is carried out according to the previous examples 1.4 (Ca(OH)₂) and 2.3 (CaSiO₃)

### 3.3—Results

### 3.3.1—Reaction Kinetics

The capture efficiency during CO₂ bubbling is reported in the following tables for each studied solution of calcium salt and amino acid.

TABLE 8.1
CO₂ capture kinetics in the presence of amino acid and Ca(OH)₂

| | |
|---|---|
| Bubbling | CO₂ capture efficiency (%) |

| time (min) | Lys 1M (invention) | Gly 2M (comparison) |
|---|---|---|
| 0 | 0 | 0 |
| 5 | 100 | 100 |
| 10 | 100 | 100 |
| 15 | 100 | 100 |
| 20 | 100 | 100 |
| 25 | 100 | 100 |
| 30 | 100 | 100 |
| 35 | 100 | 100 |
| 40 | 100 | 100 |
| 45 | 100 | 100 |
| 50 | 100 | 100 |
| 55 | 99 | 100 |
| 60 | 99 | 100 |
| 65 | 99 | 100 |
| 70 | 99 | 100 |
| 75 | 98 | 99 |
| 80 | 97 | 98 |
| 85 | 96 | 96 |
| 90 | 95 | 93 |

TABLE 8.2
CO₂ capture kinetics in the presence of amino acid and CaSiO₃

| | |
|---|---|
| Bubbling | CO₂ capture efficiency (%) |

| time (min) | Lys 1M (invention) | Gly 2M (comparison) |
|---|---|---|
| 0 | 0 | 0 |
| 5 | 100 | 100 |
| 10 | 100 | 100 |
| 15 | 100 | 100 |
| 20 | 100 | 100 |
| 25 | 99 | 100 |
| 30 | 97 | 99 |
| 35 | 95 | 96 |
| 40 | 95 | 94 |

### 3.3.2—Carbonation Rate

TABLE 9
Carbonation rate and mineralization yield of Ca(OH)₂ and CaSiO₃

| | Temp. | Alkaline | Y_{C} | Y_{CO2} |
|---|---|---|---|---|
| Amino acid | (in ° C.) | earth metal | (%) | (%) |
| LysK(CO₂) 1M | 25 | Ca(OH)₂ | 70.0 | 66.5 |
| | | CaSiO₃ | 15.9 | 15.1 |
| LysK(CO₂) 1M | 75 | Ca(OH)₂ | 63.7 | 60.5 |
| | | CaSiO₃ | 16.9 | 16.1 |

### 3.4—Conclusions

The use of lysine allows the capture and mineralization of CO₂ using mineral acceptors such as hydroxides and carbonates with a yield and kinetics at least equal to, if not greater than, the yield and kinetics obtained with glycine. Furthermore, since the solubility of Lys-CO₂ mixtures is at least twice that of Gly-CO₂ mixtures, regardless of the injected quantity of CO₂, without any increase in viscosity, the use of lysine makes it possible to work in more concentrated conditions, save water and intensify methods.

### EXAMPLE 4—CARBONATION OF ALKALINE EARTH METAL HYDROXIDE OR SILICATE

### 4.1—Implemented Method (Batch Carbonation)

The carbonation of calcium hydroxide or silicate is carried out by contacting a CO₂ atmosphere with a mixture of calcium salt in a 3N amino acid solution with one equivalent of KOH per amine end of the amino acid.

For this, 3 g of calcium salt (Ca(OH)₂ or CaSiO₃) are added to 17 ml of amino acid solution at the desired normality.

The reactor is purged and maintained at 1 atm of CO₂, closed, immersed in a bath at controlled temperature (75° C.) and then stirred at 700 rpm for 3 hours.

The obtained solid is filtered, washed with distilled water and then the solid is dried for at least 12 hours in an oven at 90° C.

### 4.2—Calculation of the Carbonation Rate and the Mineralization Yield of Calcium Hydroxide and Silicate

The calculation is carried out according to the previous examples 1.4 (Ca(OH)₂) and 2.3 (CaSiO₃).

### 4.3—Results

TABLE 10
Carbonation rate and mineralization
yield of Ca(OH)₂ and CaSiO₃ at 75° C.

| Amino acid | Alkaline earth metal | Y_{C} (%) | Y_{CO2} (%) |
|---|---|---|---|
| LysK(CO₂) 1.5M (invention) | Ca(OH)₂ | 38.5 | 36.6 |
| LysK(CO₂) 1.5M (invention) | CaSiO₃ | 17.1 | 16.2 |
| GlyK(CO₂) 3M (comparison) | CaSiO₃ | 15.1 | 13.6 |

### 4.4—Conclusions

According to the obtained experimental results, the use of basic lysine salt allows the carbonation of calcium hydroxide or silicate under different conditions while making it possible to obtain carbonation rates higher than those observed with glycine or reported in the literature.

1. A method of carbonating a mineral matrix comprising contacting a mineral matrix with an alkaline salt of a proteinogenic amino acid selected from the group consisting of alanine (Ala), arginine (Arg), asparagine (Asn), aspartate (Asp), cysteine (Cys), glutamate (Glu), glutamine (Gln), histidine (His), isoleucine (Ile), leucine (Leu), methionine (Met), phenylalanine (Phe), proline (Pro), pyrrolysine (Pyl), selenocysteine (Sec), serine (Ser), threonine (Thr), tryptophan (Trp), tyrosine (Tyr), valine (Val), and lysine (Lys) or one of its derivatives of formula (I) 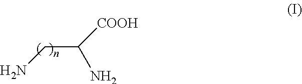
in which n is an integer equal to 1, 2, 3 or 5; and their optical isomers,
wherein the mineral matrix is an alkaline earth metal hydroxide, silicate, aluminate, phosphate, chloride or sulfate or a material containing an alkaline earth metal oxide, silicate, aluminate, phosphate, chloride or sulfate.

2. The method according to claim 1, wherein the alkaline salt is an ammonium (NH₄⁺), calcium (Ca²⁺), iron (II) (Fe²⁺) or (III) (Fe³⁺), magnesium (Mg²⁺), potassium (K⁺), sodium (Na⁺) or lithium (Li⁺) salt

3. The method according to claim 1, wherein the proteinogenic amino acid is selected as being arginine (Arg), asparagine (Asn), aspartate (Asp), cysteine (Cys), histidine (His) or lysine (Lys) and lysine (Lys) or one of its derivatives of formula (I) 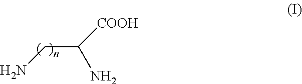
in which n is an integer equal to 1, 2, 3 or 5; and their optical isomers

4. The method according to claim 3, wherein the proteinogenic amino acid is selected as being L-arginine (L-Arg), L-asparagine (L-Asn), L-aspartate (L-Asp), L-cysteine (L-Cys), or L-lysine (L-Lys).

5. The method according to claim 4, wherein the amino acid is selected as being L-lysine (L-Lys).

6. The method according to claim 1, wherein the mineral matrix is an alkaline earth metal oxide or silicate or a material containing an alkaline earth metal hydroxide or silicate.

7. The method according to claim 1, wherein the alkaline earth metal is selected as being calcium (Ca) or magnesium (Mg).

8. The method according to claim 1, wherein the alkaline earth metal oxide is selected as being Ca(OH)₂ or Mg(OH)₂.

9. The method according to claim 1, wherein the alkaline earth metal silicate is selected as being CaSiO₃ or MgSiO₃.
